(19) United States
(12) Patent Application Publication
(10) Pub. No.: US 2017/0057553 A1
(43) Pub. Date: Mar. 2, 2017

(54) VEHICLE LOWER PORTION STRUCTURE

(71) Applicant: TOYOTA JIDOSHA KABUSHIKI KAISHA, Toyota-shi (JP)

(72) Inventor: Sota KOJIMA, Toyota-shi (JP)

(73) Assignee: TOYOTA JIDOSHA KABUSHIKI KAISHA, Toyota-shi (JP)

(21) Appl. No.: 15/220,651

(22) Filed: Jul. 27, 2016

(30) Foreign Application Priority Data
Aug. 26, 2015 (JP) 2015-166890

(51) Int. Cl. B62D 21/15; B62D 25/20

(52) U.S. Cl. CPC B62D 21/157; B62D 25/2009

(57) ABSTRACT

There is provided a vehicle lower portion structure, the structure including (1) a tunnel that is disposed at a vehicle transverse direction central portion of a floor panel of a vehicle, and that extends in a vehicle longitudinal direction, (2) a pair of rockers that are respectively disposed at vehicle transverse direction outer sides of the floor panel, and that extend in the vehicle longitudinal direction, and (3) a floor cross member that is disposed on the floor panel, and that connects the rocker and the tunnel in a vehicle transverse direction, and that is formed such that a height of the floor cross member in a vehicle vertical direction becomes higher from the tunnel side toward the rocker side, and is formed such that a width of the floor cross member in the vehicle longitudinal direction becomes wider from the rocker side toward the tunnel side.

### CROSS-REFERENCE TO RELATED APPLICATION

This application claims priority under 35 USC 119 from Japanese Patent Application No.-2015-166890 filed on Aug. 26, 2015, the disclosure of which is incorporated by reference herein.

### BACKGROUND

Technical Field

The present disclosure relates to a vehicle lower portion structure.

Related Art

Japanese Patent Application Laid-Open (JP-A) No 2010-120404 discloses a technique in which, at a floor cross member, the vehicle vertical direction heights of the rocker sides are set to be high, and a weak portion is provided as the vehicle transverse direction central portion side. In this prior art technique, at the time of a side collision of the vehicle (at the time of a so-called side collision), due to the floor cross member bending toward the lower side starting at the weak portion, bending of the floor cross member toward the vehicle cabin inner side is prevented. Note that, other than above-described JP-A No. 2010-120404, techniques relating to floor structures that consider a side collision of the vehicle are disclosed in JP-A No. 2014-124999 and JP-A No. 2014-180933 as well.

However, in the techniques disclosed in the aforementioned documents, there is room for further improvement with regard to the point of effectively transmitting the collision load at the time of a side collision of the vehicle to the side opposite the collision.

### SUMMARY

The present disclosure provides a vehicle lower portion structure that can effectively transmit collision load at the time of a side collision of a vehicle to the side opposite the collision.

A first aspect of the present disclosure is a vehicle lower portion structure including a tunnel that is disposed at a vehicle transverse direction central portion of a floor panel of a vehicle, and that extends in a vehicle longitudinal direction, a pair of rockers that are respectively disposed at vehicle transverse direction outer sides of the floor panel and that extend in the vehicle longitudinal direction, and a floor cross member that is disposed on the floor panel, and that connects the rocker and the tunnel in a vehicle transverse direction, and that is formed such that a height thereof in a vehicle vertical direction becomes higher from the tunnel side toward the rocker side, and is formed such that a width thereof in the vehicle longitudinal direction becomes wider from the rocker side toward the tunnel side.

In the vehicle lower portion structure of the above-described first aspect, the tunnel that extends in the vehicle longitudinal direction is disposed at the vehicle transverse direction central portion of the floor panel of the vehicle. The rockers that extend in the vehicle longitudinal direction are respectively disposed at the vehicle transverse direction outer sides of the floor panel. Further, the floor cross member that connects the rocker and the tunnel in the vehicle transverse direction, is disposed on the floor panel. Therefore, for example, at the time of a side collision of the vehicle or the like, the collision load that is inputted to the rocker is transmitted to the tunnel via the floor cross member.

At the time of a collision of the vehicle, the collision load is greater at the side that is near to the collision side than at the side that is far from the collision side. Therefore, at the floor cross member that connects the rocker and the tunnel, at the time of a side collision of the vehicle, a larger collision load is transmitted to the rocker side than to the tunnel side.

Therefore, in the present disclosure, at the floor cross member, the height thereof in the vehicle vertical direction is set so as to become higher from the tunnel side toward the rocker side. Namely, at the floor cross member, by making the height at the rocker side be higher than in a conventional structure, at the time when collision load of a side collision is inputted to the floor cross member, bending deformation m the vertical direction, and the like, can be suppressed at the floor cross member, mare so than in a conventional structure.

Moreover in the present disclosure, the floor cross member is formed such that the width thereof in the vehicle longitudinal direction becomes wider from the rocker side toward the tunnel side. Due thereto, at the tunnel side of the floor cross member, the collision load, that is transmitted from the rocker side of the floor cross member, can be dispersed, and the concentration of stress can be mitigated at the tunnel.

A second aspect of the present disclosure is a vehicle lower portion structure such that, in the first aspect, the floor cross member is structured to include, a front wall portion that is disposed at a vehicle longitudinal direction front portion, and that is formed such that a height thereof in the vehicle vertical direction becomes higher from the tunnel side toward the rocker side, a rear wall portion that is disposed at a vehicle longitudinal direction rear portion so as to face the front wall portion, and that is formed such that a height thereof in the vehicle vertical direction becomes higher from the tunnel side toward the rocker side, and an upper wall portion that is disposed at a vehicle vertical direction upper portion, and that connects an upper end portion of the front wall portion and an upper end portion of the rear wall portion, and that is formed such that a width thereof in the vehicle longitudinal direction becomes wider from the rocker side toward the tunnel side.

In the above-described second aspect, the floor cross member is structured to include the front wall portion and the rear wall portion and the upper wall portion. The front wall portion is disposed at the vehicle longitudinal direction front portion of the floor cross member, and is formed such that the height thereof in the vehicle vertical direction becomes higher from the tunnel side toward the rocker side. The rear wall portion is disposed at the vehicle longitudinal direction rear portion of the floor cross member so as to face the front wall portion, and this rear wall portion is formed such that the height thereof in the vehicle vertical direction becomes higher from the tunnel side toward the rocker side. Further, the upper wall portion is disposed at the vehicle vertical direction upper portion of the floor cross member, and this upper wall portion is formed such that the width thereof in the vertical longitudinal direction becomes wider from the rocker side toward the tunnel side.

In the second embodiment, the floor cross member is structured to include the front wall portion, the rear wall portion and the upper wall portion. Therefore, at the floor cross member, a ridgeline is formed along the vehicle transverse direction by the front wall portion and the upper wall portion, and a ridgeline is formed along the vehicle transverse direction by the rear wall portion and the upper wall portion. In this way, at the floor cross member, due to the ridgelines being formed along the vehicle transverse direction, the strength/rigidity of the floor cross member can be improved as compared with a case in which ridgelines are not formed.

A third aspect of the present disclosure is a vehicle lower portion structure such that, in the second aspect, a bead portion, that is formed along the vehicle transverse direction and that can transmit load, is provided at the upper wall portion.

In the vehicle lower portion structure of the third aspect, a bead portion is formed along the vehicle transverse direction at the upper wall portion, and load can be transmitted through this bead portion. Due thereto, at the floor cross member, as compared with a case in which a bead portion is not formed, the number of load transmission paths can be increased, and the concentration of stress at the tunnel can be mitigated.

As described above, the vehicle lower portion structure relating to the above-described first aspect can effectively transmit collision load, at the time of a side collision of the vehicle, to the side opposite the collision.

In the vehicle lower portion structure relating to the above-described second aspect, at the floor cross member, ridgelines are formed along the vehicle transverse direction, and collision load can be effectively transmitted through these ridgelines.

In the vehicle lower portion structure relating to the above-described third aspect, the strength/rigidity of the floor cross member can be improved due to the bead portion being formed at the upper wall portion of the floor cross member.

BRIEF DESCRIPTION OF THE DRAWINGS

Exemplary embodiments of the present disclosure will be described in detail based on the following figures, wherein:

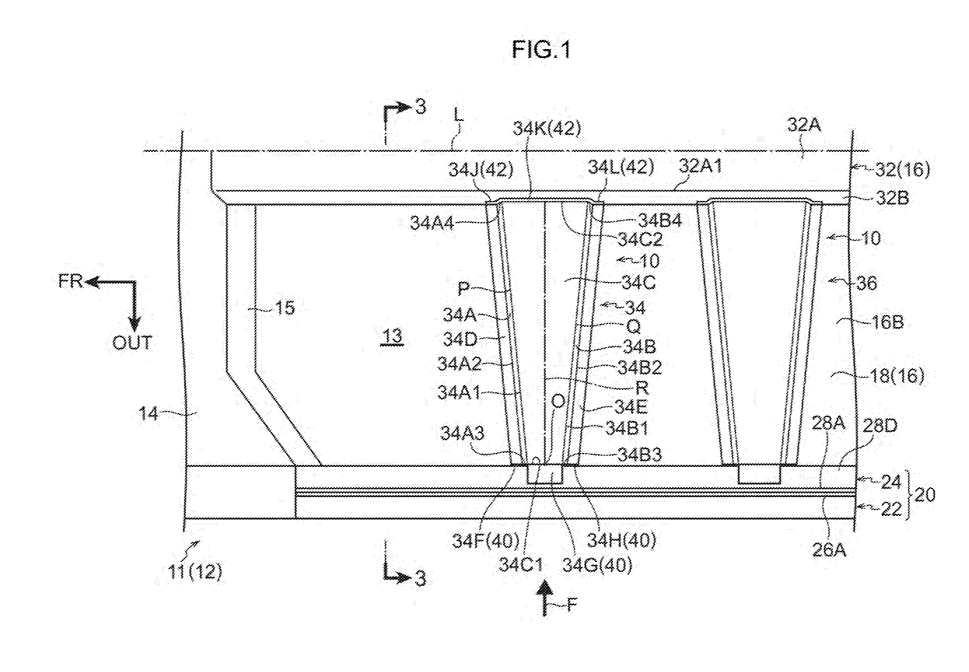

FIG. 1 is a plan view of a vehicle left side, showing a vehicle lower portion to which a vehicle lower portion structure relating to a present embodiment is applied;

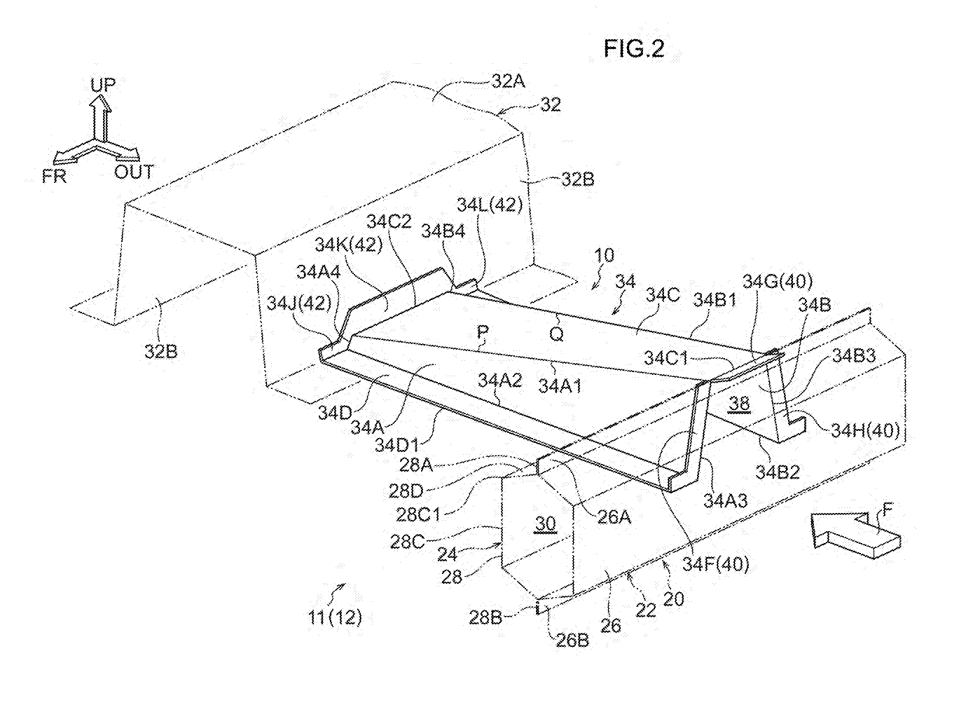

FIG. 2 is a enlarged perspective view of main portions that shows main portions of the vehicle lower portion structure relating to the present embodiment;

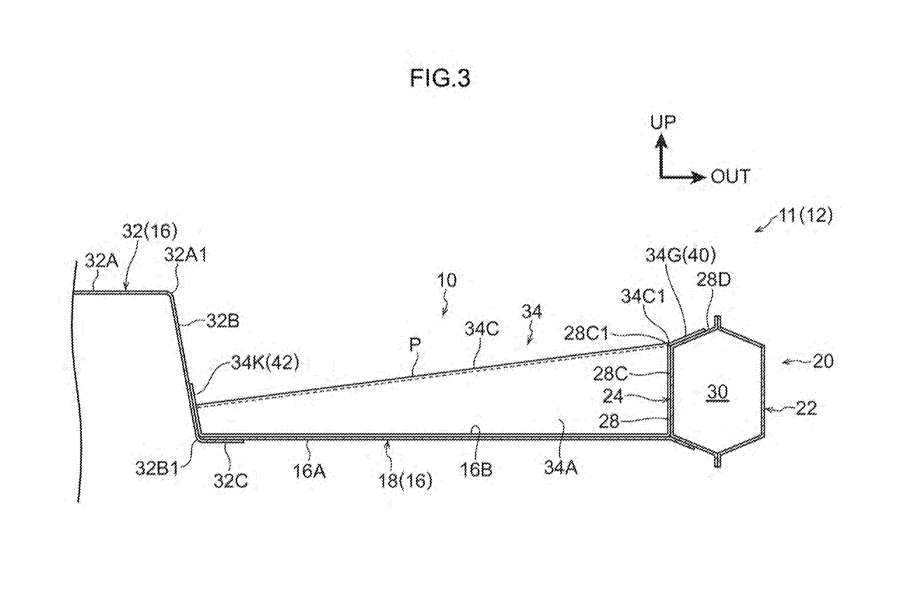

FIG. 3 is a cross-sectional view that is cut along line 3-3 of FIG. 1;

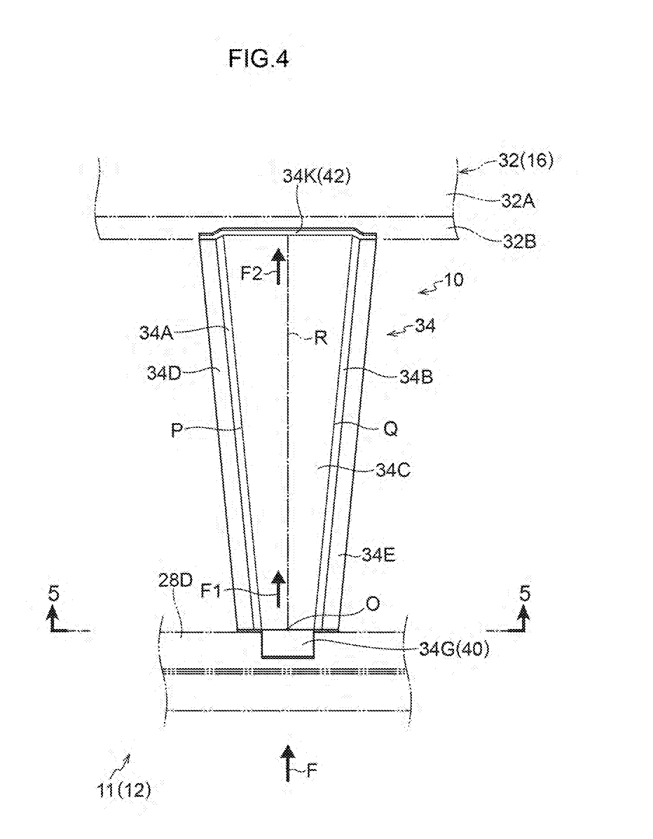

FIG. 4 is an enlarged plan view of main portions that shows main portions of the vehicle lower portion structure relating to the present embodiment;

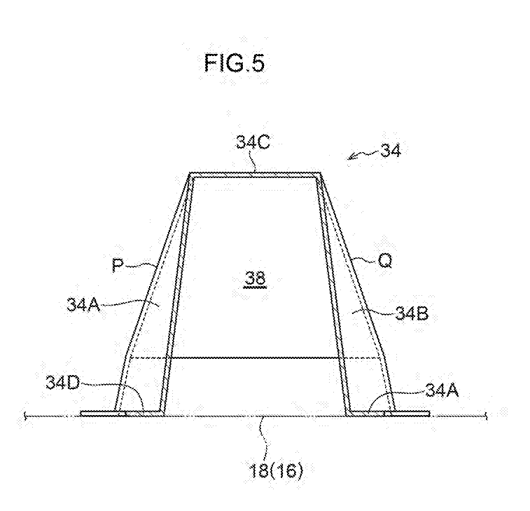

FIG. 5 is a cross-sectional view that is cut along line 5-5 of FIG. 4;

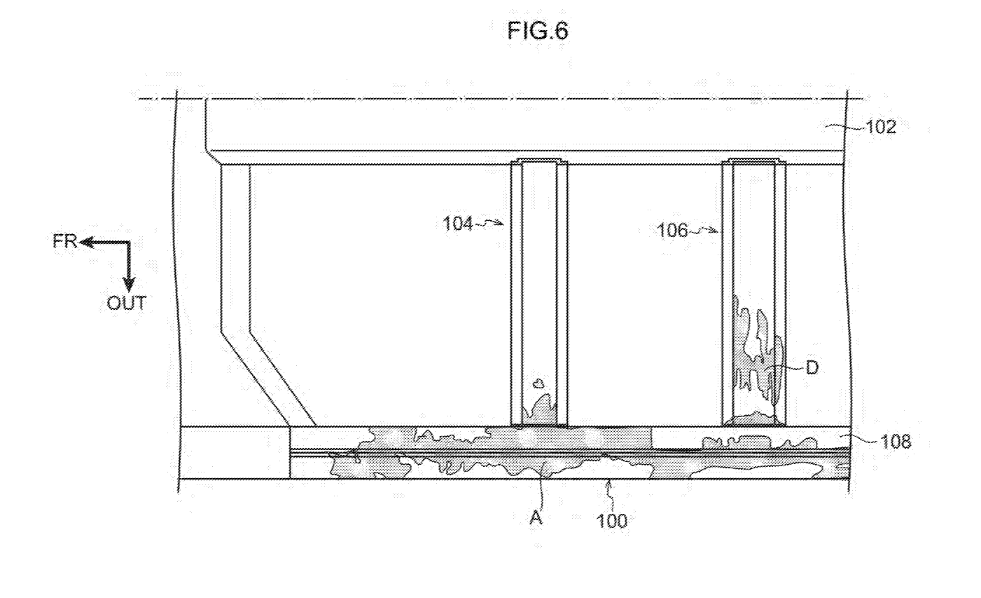

FIG. 6 is a distribution drawing of maximum stresses that are generated at respective portions at the time of a side collision of a vehicle;

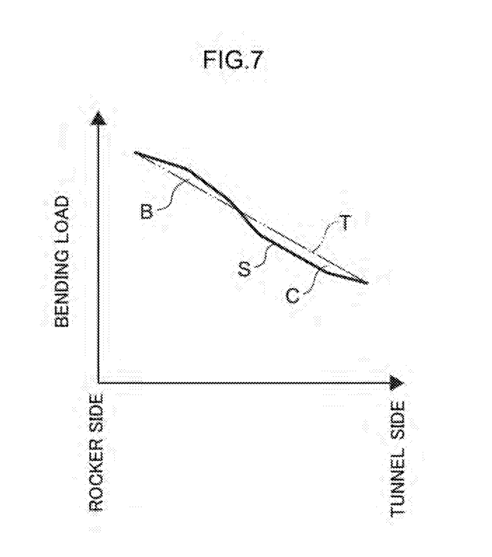

FIG. 7 is an image graph of bending loads that are generated at respective cross-sectional portions in the vehicle transverse direction of a floor cross member;

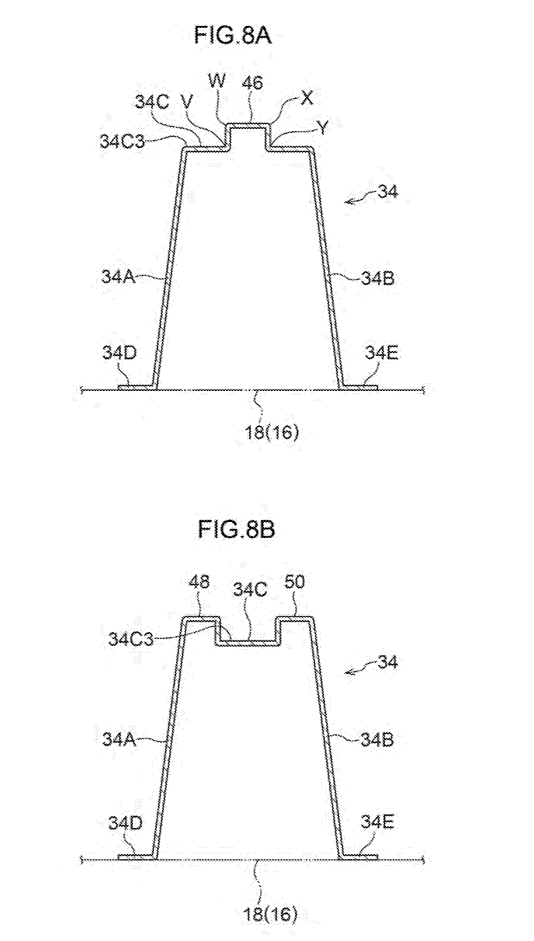

FIG. 8A is a cross-sectional view that is cut along the vehicle longitudinal direction and shows a modified example of the vehicle lower portion structure relating to the present embodiment; and

FIG. 8B is a cross-sectional view that is cut along the vehicle longitudinal direction and shows a modified example of the vehicle lower portion structure relating to the present embodiment.

### DETAILED DESCRIPTION

A vehicle lower portion structure relating to an embodiment of the present disclosure is described hereinafter by using the drawings. Note that arrow FR, arrow UP and arrow OUT that are shown appropriately in the respective drawings respectively indicate the frontward direction, the upward direction, and the outer direction of the vehicle transverse direction, of a vehicle to which the vehicle lower portion structure relating to the embodiment of the present disclosure is applied. Hereinafter, when merely longitudinal, vertical, and left-right directions are used, they indicate the longitudinal of the longitudinal direction of the vehicle, the vertical of the vehicle vertical direction, and the left and right when facing in the frontward direction, unless otherwise indicated.

(Structure of Vehicle Lower Portion Structure)

First, the structure of the vehicle lower portion structure relating to the present embodiment is described. FIG. q is a plan view showing the vehicle left side of a vehicle lower portion 11 to which a vehicle lower portion structure 10 relating to the present embodiment is applied. The vehicle lower portion 11 has left-right symmetry with respect to one-dot chain line L that is shown in FIG. 1, and in the following explanation, description will be given in accordance therewith. However, the vehicle lower portion 11 does not necessarily have to have left-right symmetry with respect to the one-dot chain line L.

As shown in FIG. 1, dash lower cross members 15 are disposed along the vehicle transverse direction at the lower portion of a dash panel 14 that partitions a vehicle cabin 13 and a power unit room (not illustrated) that is provided at the front portion of a vehicle 12. Note that, in the present embodiment, the dash lower cross members 15 are disposed between rockers 20 and a tunnel 32 that will be described later, with the tunnel therebetween, but the dash lower cross member 15 may be disposed between the left and right rockets 20 so as to cross over the tunnel 32.

Further, the front portion of a floor panel 16, that structures the floor portion of the vehicle cabin 13, is joined to the lower portion of the dash panel 14, and the dash panel 14 and the floor panel 16 are thereby made integral. Note that the dash panel 14 and the floor panel 16 may be formed integrally. Further, for example, welding by spot welding or the like is given as an example of joining in the present embodiment including in the following description as well.

As shown in FIG. 1 and FIG. 2, the rocker 20 is structured to include a rocker outer panel 22 that is disposed at the vehicle transverse direction outer side, and a rocker inner panel 24 that is disposed at the vehicle transverse direction inner side. Further, the cross-sectional shapes, that are cut along the vehicle transverse direction, of the rocker outer panel 22 and the rocker inner panel 24 are made to be substantial hat-shapes whose sides that face one another are open.

A flange portion 26A juts-out in the vehicle upward direction from the upper portion of a general portion 26 of the rocker outer panel 22, and a flange portion 28A juts-out in the vehicle upward direction from the upper portion of a general portion 28 of the rocker inner panel 24. Further, the flange portion 26A and the flange portion 28A, and a flange portion 26B and a flange portion 28B, are respectively joined by welding, and a closed cross-sectional portion 30 that extends in the vehicle longitudinal direction is thereby formed at the rocker 20.

Here, for example, the floor panel 16 is structured to include a pair of left and right floor panels 18 and the tunnel 32. Specifically, the tunnel 32 extends along the vehicle longitudinal direction at the vehicle transverse direction central portion of the floor panel 16 (between the floor panel 18 at the vehicle left side and the floor panel (not illustrated) at the vehicle right side).

The cross-sectional shape, that is cut along the vehicle transverse direction of the tunnel 32 is formed in a substantially upside-down U-shape that opens toward the lower side. The tunnel 32 has an upper wall portion 32A that structures the upper portion of the tunnel 32, and a pair of side wall portions 32B that are positioned at the left and the right of this upper wall portion 32A. As shown in FIG. 3, this pair of side wall portions 32B are made to be inclined wall portions that are respectively inclined toward the vehicle transverse direction outer sides from outer end portions 32A1, that are at the vehicle transverse direction outer sides of the upper wall portion 32A, toward the lower side. Outer flange portions 32C, that are bent toward the vehicle transverse direction outer sides of the tunnel 32, respectively extend-out from lower end portions 32B1 of the side wall portions 32B. Further, the outer flange portions 32C are respectively joined to a bottom surface 16A of the floor panel 16. Due thereto, the floor panel 16 and the tunnel 32 are made integral. Note that the floor panel 16 and the tunnel 32 may be formed integrally.

On the other hand, as shown in FIG. 1, front cross members 34 that serve as floor cross members are respectively disposed at upper surfaces 16B of the left and right floor panels 18, with the tunnel 32 therebetween. Rear cross members 36 are disposed at the rear sides of the front cross members 34, respectively.

The front cross member 34 spans between the tunnel 32 and the rocker 20 along the vehicle transverse direction, and connects the tunnel 32 and the rocker 20. As shown in FIG. 2, the cross-sectional shape, that is cut along the vehicle longitudinal direction, of the front cross member 34 is made to be a substantial hat shape that opens toward the lower side.

Specifically, as shown in FIG. 1 and FIG. 2, the front cross member 34 has a front wall portion 34A that is disposed at the front portion of the front cross member 34. A rear wall portion 34B is provided at the rear portion of the front cross member 34, so as to face the from wall portion 34A. An upper wall portion 34C, that connects an upper end portion 34A1 of the front wall portion 34A and an upper end portion 34B1 of the rear wall portion 34B, is provided at the upper portion of the front cross member 34.

Further, the front wall portion 34A, the rear wall portion 34B and the upper wall portion 34C respectively extend along the vehicle transverse direction over the entire region of the front cross member 34. Due thereto, ridgeline P is formed at the front cross member 34 along the vehicle transverse direction by the front wall portion 34A and the upper wall portion 34B and ridgeline Q is formed along the vehicle transverse direction by the rear wall portion 34B and the upper wall portion 34C.

Here, in the present embodiment, as shown in FIG. 2, FIG. 3 and FIG. 5, the front wall portion 34A and the rear wall portion 34B of the front cross member 34 are formed such that the heights thereof in the vehicle vertical direction gradually become higher at a uniform rate from the tunnel 32 side toward the rocker 20 side.

Further, as shown in FIG. 2, FIG. 4 and FIG. 3, the upper wall portion 34C of the front cross member 34 is formed such that the vehicle longitudinal direction width thereof gradually becomes wider at a uniform rate from the rocker 20 side toward the tunnel 32 side. For example, this upper wall portion 34C is formed m the shape of an isosceles trapezoid that has line symmetry in the vehicle longitudinal direction with respect to a straight line (central lines R that passes through a vehicle longitudinal direction central portion O at the rocker 20 side and extends in the vehicle transverse direction.

However, the shape of the upper wall portion 34C is not necessarily limited to this. For example, although not illustrated, the upper wall portion 34C may be formed such that the width of the front cross member 34 in the vehicle longitudinal direction widens due to the rear wall portion 34B moving away from the front wall portion 34A from the rocker 20 side toward the tunnel 32 side, centered around the front wall portion 34A.

On the other hand, as shown in FIG. 1 and FIG. 2, a front flange portion 34D that is bent toward the front extends-out from a lower end portion 34A2 of the front wall portion 34A, and a rear flange portion 34E that is bent toward the rear extends-out from a lower end portion 34B2 of the rear wall portion 34B. Further, the front flange portion 34D and the rear flange portion 34E are respectively joined by welding or the like to the upper surface 16B of the floor panel 16. Due thereto, a closed cross-sectional portion 38 is formed by the front cross member 34 and the floor panel 16.

Further, at the rocker 20 side of the front cross member 34, a front flange portion 34F, that is bent toward the front side with respect to the front wall portion 34A, extends-out from an outer end portion 34A3 of the front wall portion 34A. This front flange portion 34F is formed in a substantial L-shape as seen in a side view seen from the tunnel 32 side, and extends-out to a front end portion 34D1 of the front flange portion 34D. Note that a rear flange portion 34H, a front flange portion 34J and a rear flange portion 34L that are described later also are formed in substantial L-shapes, in the same way as this front flange portion 34F.

Further, at the rocker 20 side of the front cross member 34, an upper flange portion 34G, that is bent toward the upper side and the vehicle transverse direction outer side with respect to the upper wall portion 34C, extends-out from an outer end portion 34C1 of the upper wall portion 34C. Moreover, at the rocker 20 side of the front cross member 34, the rear flange portion 34H, that is bent toward the rear side with respect to the rear wall portion 34B, extends-out front an outer end portion 34B3 of the rear wall portion 34B.

The front flange portion 34F, the upper flange portion 34G and the rear flange portion 34H are made to be a joining portion 40 that is substantially upside-down U-shaped as seen in a side view seen from the rocker 20 side. This joined portion 40 is joined by welding or the like to the rocker inner panel 24.

Here, as shown in FIG. 3, the general portion 28 of the rocker inner panel 24 has a vertical wall portion 28C that structures the central portion in the vehicle vertical direction and that is formed along the vehicle vertical direction. An upper inclined wall portion 28D, that is inclined obliquely upward while heading toward the vehicle transverse direction outer side is provided at the upper side of this vertical wall portion 28C. The height of the outer end portion 34C1 of the upper wall portion 34C of the front cross member 34 is set so as to be substantially the same height as an upper end portion 28C1 of the vertical wall portion 28C of the rocker inner panel 24.

Therefore, as shown in FIG. 1 and FIG. 2, of the joining portion 40, the front flange portion 34F and the rear flange portion 34H are joined to the vertical wall portion 28C of the rocker inner panel 24, and the upper flange portion 34G is joined to the upper inclined wall portion 28D of the rocker inner panel 24. Note that it suffices for the upper flange portion 34G to be able to be joined to the upper inclined wall portion 28D. Therefore, the height of the outer end portion 34C1 of the upper wall portion 34C of the front cross member 34 does not necessarily have to be set so as to be substantially the same height as the upper end portion 28C1 of the vertical wall portion 28C of the rocker inner panel 24.

On the other hand, at the tunnel 32 side of the front cross member 34, the front flange portion 34J, that is bent toward the front side with respect to the front wall portion 34A, extends-out from an inner end portion 34A4 of the front wall portion 34A. Further, at the tunnel 32 side of the front cross member 34, an upper flange portion 34K, that is bent toward the upper side with respect to the upper wall portion 34C, extends-out from an inner end portion 34C2 of the upper wall portion 34C. Moreover, at the tunnel 32 side of the front cross member 34, the rear flange portion 34L, that is bent toward the rear side with respect to the rear wall portion 34B, extends-out from an inner end portion 34B4 of the rear wall portion 34B.

The front flange portion 34J, the upper flange portion 34K and the rear flange portion 34L are made to be a joined portion 42 that is substantially upside-down U-shaped as seen in a side view seen from the tunnel 32 side. This joined portion 42 is joined by welding or the like to the side wall portion 32B of the tunnel 32.

In this way, the front cross member 34 connects the tunnel 32 and the rocker 20 in the vehicle transverse direction on the floor panel 16.

(Operation of Vehicle Lower Portion Structure)

Operation of the vehicle lower portion structure relating to the present embodiment is described next. As shown in FIG. 1 and FIG. 2, in the present embodiment, the front cross member 34 connects the tunnel 32 and the rocker 20 in the vehicle transverse direction. Therefore, at the time of a side collision of the vehicle 12 (at the time of a side collision) or the like, collision load F that is inputted to the rocker 20 is transmitted via the front cross member 34 to the tunnel 32.

Here, in the present embodiment, the front cross member 34 is formed such that the height thereof in the vehicle vertical direction becomes gradually higher from the tunnel 32 side toward the rocker 20 side, and is formed such that the width thereof in the vehicle longitudinal direction becomes gradually wider from the rocker 20 side toward the tunnel 32 side.

At the time of a collision of the vehicle, the collision load is greater at the side that is near to the collision side than at the side that is far from the collision side. For example, FIG. 6 is illustrated as a general example, and here, at the time of a side collision of a vehicle, region A to which particularly large collision load is inputted is shown by the darker dots. As shown in this drawing, it can be understood that, at a front cross member 104 that connects a rocker 100 and a tunnel 102, at the time of a side collision of the vehicle, a larger collision load is inputted to the rocker 100 side than to the tunnel 102 side.

Further, FIG. 7 shows by solid line S an image of the bending load as the collision load that is generated at respective cross-sections in the vehicle transverse direction and that is inputted to the front cross member at the time of a side collision of a vehicle for example. The straight line that connects the both end portions of this solid line S is shown as two-dot chain line T. The values shown by this two-dot chain line T are the yield strength with respect to the bending load at the front cross member.

As shown in this drawing, at the front cross member, the collision load is gradually absorbed from the rocker 20 (see FIG. 1) side toward the tunnel 32 (see FIG. 1) side. Therefore, the yield strength that is required of the front cross member also gradually becomes smaller from the rocker 20 side toward the tunnel 32 side.

Further, as shown in FIG. 7, at the rocker 20 side of the front cross member, the yield strength that is shown by the two-dot chain line T is smaller than the bending load that is shown by solid line S (region B). Namely, in this region B, the yield strength of the front cross member is less than the bending load that is inputted to the front cross member, and this means that there is the possibility that the rocker 20 side of the front cross member will deform relatively greatly.

In this case, in order to increase the yield strength of the front cross member, the rigidity of the front cross member should be increased. For example, in making the rigidity of the front cross member higher, it can be thought to make the height of the front cross member higher, but if the height of the front cross member is made higher, the amount of material therefor and the cost thereof will increase.

On the other hand, as shown in FIG. 7, at the tunnel 32 (see FIG. 1) side of the front cross member, the yield strength that is shown by the two-dot chain line T is greater than the bending load that is shown by solid line S (region C). Namely, it can be understood that, in this region C, there is excess yield strength at the front cross member. Accordingly, if the front cross member is designed such that substantially the same rigidity is maintained all the way to the tunnel 32 side of the front cross member in accordance with the rigidity that is required at the rocker 20 side of the front cross member as described above, there is excessive design at the tunnel 32 side of the front cross member.

Therefore, in the present embodiment, as described above, the front cross member 34 that is shown in FIG. 1 and FIG. 2 is formed such that the height thereof in the vehicle vertical direction gradually becomes higher from the tunnel 32 side toward the rocker 20 side. Due thereto, at the front cross member 34, from the tunnel 34 side toward the rocker 20 side, the cross-sectional secondary moment increases, and the rigidity of the front cross member 34 can be increased. Note that, at the tunnel 32 side of the front cross member 34, there is a state in which the requisite rigidity is ensured.

In accordance with the present embodiment, at the time when the collision load F at the time of a side collision is inputted from the rocker 20 the front cross member 34, the bending deformation in the vertical direction, and the like, of the front cross member 34 can be suppressed more than in a conventional structure by as amount corresponding to the amount by which the height of the front cross member 34 is increased. Namely, the axial force that is inputted along the axial direction of the front cross member 34 at the time of a side collision of the vehicle, and the deformation of the front cross member 34 with respect to bending at the time of a side collision of the vehicle, are suppressed, and the collision load F can be effectively transmitted.

Moreover in the present embodiment, as shown in FIG. 4, the front cross member 34 is formed such that the width thereof in the vehicle longitudinal direction becomes wider from the rocker 20 side low toward the tunnel 32 side. Due thereto, at the tunnel 32 side of the front cross member 34, collision load F2 that is transmitted from the rocker 20 side of the front cross member 34 can be dispersed in the vehicle longitudinal direction, and the concentration of stress can be mitigated at the side wall portion 32B of the tunnel 32.

As described above, in the present embodiment, at the front cross member 34 that is shown in FIG. 2 and FIG. 4, the height at the rocker 20 side is increased, and bending deformation in the vertical direction and the like are suppressed, and, at the tunnel 32 side, the width in the vehicle longitudinal direction is increased, and the collision load F2 is dispersed, and the concentration of stress can be mitigated at the side wall portion 32B of the tunnel 32.

Namely, in accordance with the present embodiment, deformation of the front cross member 34 and the tunnel 32 can be suppressed, and the collision load F at the time of a side collision of the vehicle can be effectively transmitted toward the side opposite the collision. Further, at the tunnel 32 side of the front cross member 34, the height thereof can be made to be low while the required rigidity thereof is ensured, and therefore, the weight can be lightened by an amount corresponding to the amount by which the tunnel 32 side is made shorter.

Further, in the present embodiment, as shown in FIG. 2, the rigidity of the front cross member 34 can be improved merely by changing the shape of the front cross member 34. Therefore, as compared with a case in which a separate reinforcing member is provided at the front cross member 34, a reduction in the number of parts and suppression of an increase in cost can be devised.

Moreover, in the present embodiment, as shown in FIG. 2 and FIG. 4, the front cross member 34 is structured to include the front wall portion 34A and the rear wall portion 34B and the upper wall portion 34C. The front wall portion 34A, the rear wall portion 34B and she upper wall portion 34C respectively extend along the vehicle transverse direction. Due thereto, at the front cross member 34, the ridgeline P is formed along the vehicle transverse direction by the front wall portion 34A and the upper wall portion 34C, and the ridgeline Q is formed along the vehicle transverse direction by the rear wall portion 34B and the upper wall portion 34C.

In this way, at the front cross member 34, due to the ridgelines P, Q being formed along the vehicle transverse direction, the strength/rigidity of the front cross member 34 can be improved, as compared with a case in which the ridgelines P, Q are not formed. Further, the ridgelines P and Q are some of the load transmission paths, and the collision load F can be effectively transmitted through the ridgelines P, Q.

On the other hand, in the present embodiment, the upper flange portion 34G is joined to the upper inclined wall portion 28D of the rocker inner panel 24, at the joined portion 40 of the front cross member 34 and the rocker 20. Although not illustrated, if, for example, the upper flange portion 34G were to be joined to the vertical wall portion 28C of the rocker inner panel 24, at the rocker 20 side of the front cross member 34, in a case in which the height thereof were to be made higher than in a conventional structure, the contact surface area of the upper flange portion 34G would be small. However, in the present embodiment, because the upper flange portion 34G is joined to the upper inclined wall portion 28D of the rocker inner panel 24, the contact surface area of the upper flange portion 34G is sufficiently ensured, and further, the joined surface area can be increased also.

Further, at the joined portion 42 of the front cross member 34 and the tunnel 32, the upper flange portion 34K is joined to the side wall portion 32B of the tunnel 32. Therefore, at the tunnel 32 side of the front cross member 34 the joined surface area of the upper flange portion 34K can be increased by an amount corresponding to the amount by which the height of the front cross member 34 is set to be lower than in a conventional structure.

By increasing the joined surface areas of the upper flange portions 34G, 34K as described above, the number of points of joining of the rocker 20 and the tunnel 32 can be increased. Due thereto, the joining strength can be improved, and the load transmission efficiency can be increased further.

(Modified Examples of Embodiment)

Note that, in the present embodiment, as shown in FIG. 2 and FIG. 3, the front wall portion 34A and the rear wall portion 34B of the front cross member 34 are formed such that the heights thereof in the vehicle vertical direction gradually become higher at a uniform rate from the tunnel 32 side toward the rocker 20 side. However, the heights of the front wall portion 34A and the rear wall portion 34B do not necessarily have to gradually become higher at a uniform rate. Namely, the ridgelines P, Q may be formed by plural straight lines. Further, the ridgelines P, Q may be formed by curves, or may be formed by straight lines and curves.

Moreover, as shown in FIG. 4 and FIG. 5, the upper wall portion 34C of the front cross member 34 is formed such that the width thereof in the vehicle transverse direction gradually becomes wider at a uniform rate from the rocker 20 side toward the tunnel 32 side. However, in the same way as the heights of the front wall portion 34A and the rear wall portion 34B, the width of the upper wall portion 34C does not necessarily have to gradually become wider at a uniform rate.

Further, in the above-described embodiment, the upper wall portion 34C of the front cross member 34 is a flat surface. However, as shown in FIG. 8A, a bead portion 46 that can transmit load may be formed at the upper wall portion 34C. Specifically, the bead portion 46 is formed at a top surface 34C3 side of the upper wall portion 34C, along a central line R (see FIG. 1) and over the entire vehicle transverse direction region of the front cross member 34. The cross-sectional shape, when cut along the vehicle longitudinal direction, of this bead portion 46 is formed in a rectangular wave shape whose lower side is open, and the bead portion 46 is convex toward the upper side. By forming this bead portion 46, ridgelines V, W, X, Y are formed at the upper wall portion 34C of the front cross member 34.

By forming the bead portion 46 at the upper wall portion 34C of the front cross member 34 in this way, at the front cross member 34, the strength rigidity of the front cross member 34 can be improved as compared with a case in which the bead portion is not formed. Further, by forming the bead portion 46, the ridgelines V, W, X, Y ate formed at the upper wall portion 34C of the front cross member 34. Due thereto, the strength rigidity of the front cross member 34 can be improved more, and the collision load F (see FIG. 1) can be transmitted more effectively.

Further, in addition to this, as shown in FIG. 8B, bead portions 48 50, that are convex and are provided integrally with the front wall portion 34A, the rear wall portion 34B respectively, may be provided at the upper wall portion 34C of the front cross member 34. Note that the bead portions 46, 48, 50 are respectively formed so as to be convex from the top surface 34C3 of the upper wall portion 34C, but, of course, may be formed so as to be concave. Moreover, in these embodiments, the bead portions 46, 48, 50 are respectively formed over substantially the entire region in the vehicle transverse direction of the front cross member 34, bit may be formed at a portion in the vehicle transverse direction of the front cross member 34.

Further, other than bead portions, for example, a so-called patch member that is plate-shaped may be joined to a place where reinforcement is desired at the front cross member 34, although such a structure is not illustrated. As a place where reinforcement is desired, for example, at the rocker 20 side of the front cross member 34, a plate-shaped patch member may be joined to the obverse side or the reverse side of the front cross member 34, including the ridgelines P, Q.

Here, description is given of the front cross member 34 in the above-described embodiments, but the rear cross member 36 that is shown in FIG. 1 as well is formed in a shape that is similar to that of the front cross member 34. However, as shown in FIG. 6, a center pillar 108 is disposed at the vehicle transverse direction outer side of a rear cross member 106, and therefore, some of the collision load is inputted by this center pillar 108 as well. Therefore, at the rear cross member 106, region D exists, in addition to region A, as a region where a large collision load is inputted.

Therefore, at the rear cross member 36 (see FIG. 1), although not illustrated, reinforcing by a patch member may be carried out at region D (see FIG. 6). Further, the rear cross member 36 may be formed such that the height thereof in the vehicle vertical direction becomes higher from the tunnel 32 side toward the region D side, and the height of the rear cross member 36 is substantially the same from the region D to the rocker 20.

Although an embodiment of the present disclosure has been described above, the present disclosure is not limited to this embodiment, and the embodiment and various modified examples may be used by being combined appropriately. Further, the present disclosure can, of course, be embodied in various forms within a scope that does not depart from the gist thereof.

What is claimed is:

1. A vehicle lower portion structure comprising:
a tunnel that is disposed at a vehicle transverse direction central portion of a floor panel of a vehicle, and that extends in a vehicle longitudinal direction;
a pair of rockers that are respectively disposed at vehicle transverse direction outer sides of the floor panel, and that extend in the vehicle longitudinal direction; and
a floor cross member that is disposed on the floor panel, and that connects the rocker and the tunnel in a vehicle transverse direction, and that is formed such that a height of the floor cross member in a vehicle vertical direction becomes higher from the tunnel side toward the rocker side, and is formed such that a width of the floor cross member in the vehicle longitudinal direction becomes wider from the rocker side toward the tunnel side.

2. The vehicle tower portion structure of claim 1, wherein the floor cross member is structured to include:
a front wall portion that is disposed at a vehicle longitudinal direction front portion, and that is formed such that a height of the front wall portion in the vehicle vertical direction becomes higher from the tunnel side toward the rocker side;
a rear wall portion that is disposed at a vehicle longitudinal direction rear portion so as to face the front wall portion, and that is formed such that a height of the rear wall portion in the vehicle vertical direction becomes higher from the tunnel side toward the rocker side, and
an upper wall portion that is disposed at a vehicle vertical direction upper portion, and that connects an upper end portion of the front wall portion and an upper end portion of the rear wall portion, and that is formed such that a width of the upper wall in the vehicle longitudinal direction becomes wider from the rocker side toward the tunnel side.

3. The vehicle lower portion structure of claim 2, wherein a bead portion, that is formed along the vehicle transverse direction and that can transmit load, is provided at the upper wall portion.
